(19) United States
(12) Patent Application Publication
(10) Pub. No.: US 2024/0120674 A1
(43) Pub. Date: Apr. 11, 2024

(54) TERMINAL MODULE AND CONNECTOR

(71) Applicant: SUMITOMO WIRING SYSTEMS, LTD., Mie (JP)

(72) Inventor: Takayuki UCHIYAMA, Mie (JP)

(21) Appl. No.: 18/283,195

(22) PCT Filed: Aug. 17, 2021
(86) PCT No.: PCT/JP2021/030048

§ 371 Date: Sep. 20, 2023

(30) Foreign Application Priority Data
Mar. 31, 2021 (JP) 2021-059260

(51) Int. Cl. H01R 13/15; H01R 13/24

(52) U.S. Cl. CPC H01R 13/15; H01R 13/24; H01R 2201/26

(57) ABSTRACT

A terminal module mates to a mating connector that relatively approaches the terminal module from a first side to a second side along a first direction (z direction) and electrically connects to the mating connector. The terminal module includes a first terminal provided so as to be movable toward the second side by being pressed by the mating connector; a second terminal that is positioned at a distance from the first terminal in a second direction (x direction) that is perpendicular to the first direction; and a flexible conductor that electrically connects the first terminal and the second terminal. The first terminal includes a first part that is provided so as to be capable of contacting the mating connector and a second part that extends from a second terminal side end of the first part toward the first side or the second side.

### TECHNICAL FIELD

The present disclosure relates to a terminal module and a connector.

The present disclosure is based upon and claims the benefit of priority of the prior Japanese Patent Application No. 2021-059260, filed on Mar. 31 2021, the entire contents of which are incorporated herein by reference.

### BACKGROUND

When connecting devices, such as a motor and a PCU (Power Control Unit), in an automobile or the like, there is a known technology in which connectors that are respectively provided on cases of the devices are mate together, which saves space by omitting a wire harness. For example, Patent Document 1 discloses a technology in which a mating connector that is to be inserted is mated together with a connector for receiving insertion.

In Patent Document 1, the connector includes a coil spring and an electrical contact member provided at the front end of the coil spring. When the connectors are mated together, a mating contact included in the mating connector compresses the coil spring via the electrical contact member. By doing so, the electrical contact member is pressed against the mating contact by the coil spring, resulting in the electrical contact member and the mating contact becoming electrically connected.

The electrical contact member is electrically connected to an external connection member by a braided wire. The braided wire is provided so as to flex as the electrical contact member moves. This flexing of the braided wire enables the electrical contact member to move while maintaining the electrical connection with the external connection member when the mating contact is connected to the electrical contact member.

### PRIOR ART DOCUMENT

### Patent Document

Patent Document 1: JP 2018-101556 A

### SUMMARY OF THE INVENTION

A terminal module according to the present disclosure is a terminal module for mating to a mating connector that relatively approaches the terminal module from a first side to a second side along a first direction and for electrically connecting to the mating connector, the terminal module including: a case including a ceiling wall and a pair of side walls that extend from the ceiling wall toward the first side; an elastic member that extends from the ceiling wall toward the first side; a first terminal that is supported on the pair of side walls in a state where the first terminal is biased toward the first side by the elastic member, and is provided so as to be movable toward the second side by being pressed by the mating connector; a second terminal that extends in the first direction and is positioned so as to be separated from the first terminal in a second direction that is perpendicular to the first direction; and a flexible conductor that electrically connects the first terminal and the second terminal, wherein the first terminal includes: a first part that is provided on the first side of the elastic member and opposite the ceiling wall in the first direction and is capable of contacting the mating connector; and a second part that extends toward the first side or the second side from an end portion on the second terminal side of the first part, and the flexible conductor includes: a first joint portion that is connected to the second part; a second joint portion that is connected to the second terminal; and an intermediate part that is positioned between the first joint portion and the second joint portion and is convex toward the first side.

### BRIEF DESCRIPTION OF THE DRAWINGS

FIG. 1 is a cross-sectional view schematically depicting a connector and a mating connector according to an embodiment in an unmated state.

FIG. 2 is a cross-sectional view schematically depicting the connector and the mating connector according to the present embodiment in the process of mating.

FIG. 3 is a cross-sectional view depicting the connector and the mating connector according to the present embodiment in a mated state.

FIG. 4 is a perspective view of the terminal module according to the present embodiment when looking diagonally from upper left.

FIG. 5 is a front view of the terminal module in FIG. 3 when looking from the front.

FIG. 6 is a side view of the terminal module in FIG. 3 when looking from the left.

FIG. 7 is a plan view of the terminal module of FIG. 3 when looking from above.

FIG. 8 is a cross-sectional view of the terminal module that has been cut along a cutting line indicated by arrow VIII in FIG. 5.

FIG. 9 is a diagram schematically depicting the state of the flexible conductor when the mating connector is mated with the connector.

FIG. 10 is a diagram schematically depicting the state of the flexible conductor when the mating connector is removed from the connector.

FIG. 11 is a cross-sectional view schematically depicting a terminal module according to a modification.

FIG. 12 is a cross-sectional view schematically depicting a terminal module according to a modification.

FIG. 13 is a cross-sectional view schematically depicting a connector according to a modification.

### DETAILED DESCRIPTION TO EXECUTE THE INVENTION

### Problem to be Solved by the Present Disclosure

As indicated in Patent Document 1, for a connector which involves a member that moves during mating, a flexible conductor such as a braided wire is used to electrically connect the part that moves (here, the electrical contact member) and the part that is fixed (here, the external connection member). Since the flexible conductor is composed of a relatively flexible electric wire or the like, there is the risk of disconnection due to the electric wire rubbing against other members (as one example, the housing) included in the connector. Since it is difficult to completely predict how the flexible conductor will flex when the connector is mated, in order to prevent disconnection, it is necessary to provide the housing for example with a space in an amount corresponding to the range of movement of the flexible conductor plus an additional margin. This results in the problem of an increase in the size of the connector and is an obstacle to saving space.

In view of the above problems, it is an object of the present disclosure to provide a terminal module that enables a connector to be downsized while suppressing disconnection of a flexible conductor. A further object of the present disclosure is to provide a connector that can be downsized while suppressing disconnection of a flexible conductor.

### Effect of the Invention

According to the present disclosure, it is possible to downsize a connector while suppressing disconnection of a flexible conductor.

### Overview of Embodiments of the Present Disclosure

As an overview, embodiments of the present disclosure include the following configurations.

(1) A terminal module according to the present disclosure is a terminal module for mating to a mating connector that relatively approaches the terminal module from a first side to a second side along a first direction and for electrically connecting to the mating connector, the terminal module including: a case including a ceiling wall and a pair of side walls that extend from the ceiling wall toward the first side; an elastic member that extends from the ceiling wall toward the first side; a first terminal that is supported on the pair of side walls in a state where the first terminal is biased toward the first side by the elastic member, and is provided so as to be movable toward the second side by being pressed by the mating connector; a second terminal that extends in the first direction and is positioned so as to be separated from the first terminal in a second direction that is perpendicular to the first direction; and a flexible conductor that electrically connects the first terminal and the second terminal, wherein the first terminal includes: a first part that is provided on the first side of the elastic member and opposes the ceiling wall in the first direction and is capable of contacting the mating connector; and a second part that extends toward the first side or the second side from an end portion on the second terminal side of the first part, and the flexible conductor includes: a first joint portion that is connected to the second part; a second joint portion that is connected to the second terminal; and an intermediate part that is positioned between the first joint portion and the second joint portion and protrudes toward the first side.

During mating, the first terminal moves toward the second side relative to the second terminal. Together with this, one portion of the flexible conductor also moves toward the second side. An intermediate part of the flexible conductor flexes to protrude toward the first side. This means that the direction in which the portion of the flexible conductor moves during mating is opposite the direction in which the intermediate part of the flexible conductor protrudes. As a result, since the range of movement of the flexible conductor can be accommodated within the space surrounded by the flexible conductor before mating, it is possible to make the space provided for the range of movement of the flexible conductor smaller. By doing so, it is possible to downsize the connector while suppressing disconnection of the flexible conductor.

(2) It is preferable, before mating, for the intermediate part to flex so that one portion of the intermediate part is positioned closer to the second joint portion than an imaginary line that connects the first joint portion and a top portion on the first side of the intermediate part, and during mating, for the one portion to extend so that the one portion moves from the second joint portion side of the imaginary line to a side opposite to the second joint portion.

With this configuration, before mating, one portion of the intermediate part flexes so as to protrude inward. This means that the space in which the flexible conductor is accommodated before mating can be made smaller. Since the flexed part extends during mating, it is possible to suppress swinging of the flexible conductor during mating, which makes it possible to suppress rubbing of the flexible conductor against the housing.

(3) It is preferable for the first joint portion to be connected to a first surface on a second terminal side of the second part, and for the second joint portion to be connected to a second surface on a second part side of the second terminal.

If the flexible conductor rubs against the first side end of the second terminal, there is the risk of abrasion of the flexible conductor. According to the above aspect of the present disclosure, since the second joint portion is connected to the second surface on the second part side of the second terminal and the intermediate part is provided on the second part side from the second joint portion, it is possible to prevent the flexible conductor from rubbing against the first side end of the second terminal. By doing so, disconnection of the flexible conductor can be further suppressed.

(4) It is preferable for at least part of the first surface to be at a position that overlaps the second surface in the first direction.

With the above configuration, it is possible to reduce the width in the first direction of the space required to accommodate the flexible conductor connected to the first surface and the second surface.

(5) It is preferable for the pair of side walls to include a guide surface that guides the first terminal, which is pressed by the mating connector and moves toward the second side, so as to move in a direction where the first terminal approaches the second terminal, and for an amount of movement of the first terminal toward the second side during mating to be greater than an amount of movement in a direction approaching the second terminal.

With the above configuration, when the mating connector is mated, part of the flexible conductor advances into the space that is surrounded by the flexible conductor before mating and is open to the second side. As a result, since the range of movement of the flexible conductor can be accommodated in this space, it is possible to downsize the connector while suppressing disconnection of the flexible conductor.

(6) A connector according to the present disclosure is a connector including: the terminal module according to any one of (1) to (5) above, and a housing for housing the terminal module.

(7) It is preferable for the housing to include an upper wall that is contacted by the ceiling wall and a rear wall that extends from a second terminal side end of the upper wall toward the first side, wherein before mating, a space surrounded by the upper wall, the rear wall, and the case may be formed on the second side of the second part and the first joint portion, and during mating, the second part and the first joint portion may advance into the space.

The space surrounded by the upper wall, the rear wall, and the case is a space originally provided as the range of movement of the first terminal. In this aspect of the present disclosure, the space can be used as the range of movement of the flexible conductor in addition to the range of movement of the first terminal, which makes it possible to downsize the connector.

(8) It is preferable for the housing to include an inclined wall that acts as a partition between the mating connector and the flexible conductor during mating and for the inclined wall to include an inclined surface that is positioned closer to the first joint portion than a top portion on the first side of the intermediate part and approaches the first joint portion from the first side toward the second side.

Since the inclined surface is inclined in the same direction as the direction in which the intermediate part is inclined toward the first joint portion, it is possible to prevent the inner surface of the housing from coming into contact with the flexible conductor. Even if the flexible conductor contacts the flexible conductor, since the inclined surface is a surface along the direction of inclination of the intermediate member, it is possible to suppress abrasion of the flexible conductor when contact occurs.

(9) It is preferable, when the connector is removed from the mating connector, for the inclined surface to guide the intermediate part by contacting the intermediate part that moves toward the first side.

With the above configuration, it is possible to prevent the flexible conductor from flexing into an unintended shape and to suppress rubbing of the flexible conductor against an unintended part of the housing.

(10) The connector preferably includes a guide portion that is positioned in a space that is surrounded by the flexible conductor before the mating and is open to the second side, and the guide portion may contact the intermediate part during the mating.

By using the above configuration, it is possible for the flexible conductor to maintain a protruding shape that protrudes toward the first side. By doing so, disconnection of the flexible conductor due to unpredictable flexing can be suppressed.

### Detailed Description of Embodiments of the Present Disclosure

Several embodiments of the present disclosure will now be described in detail with reference to the attached drawings.

Overall Configuration of Connector

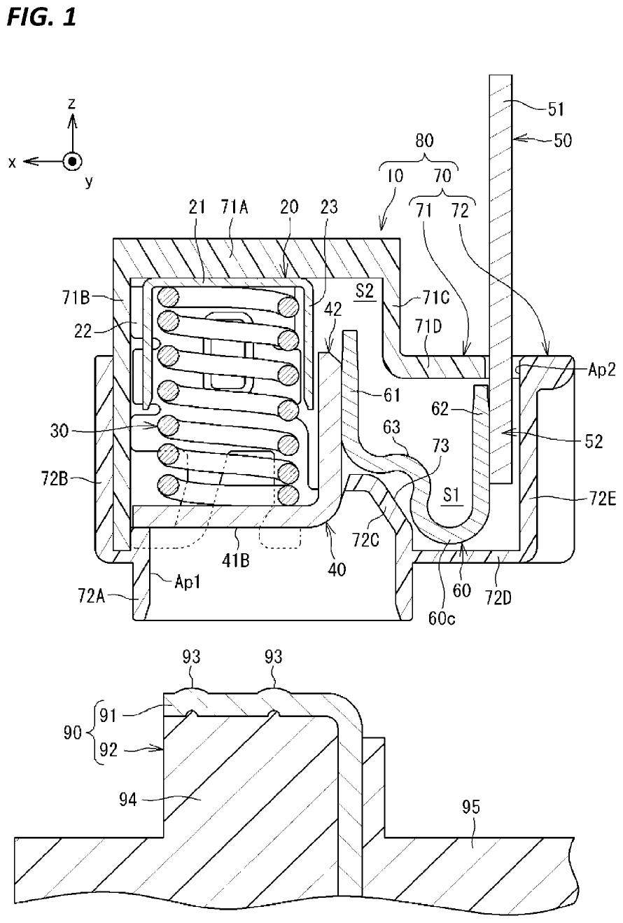

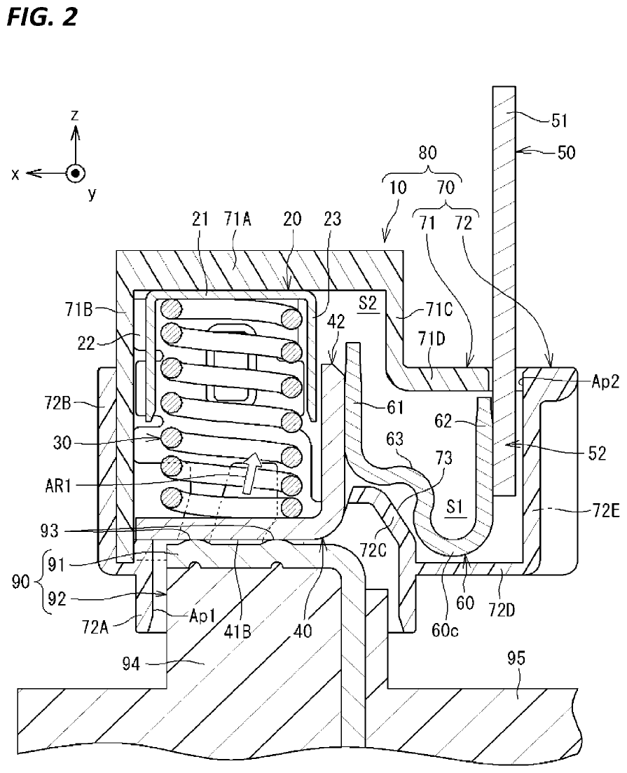

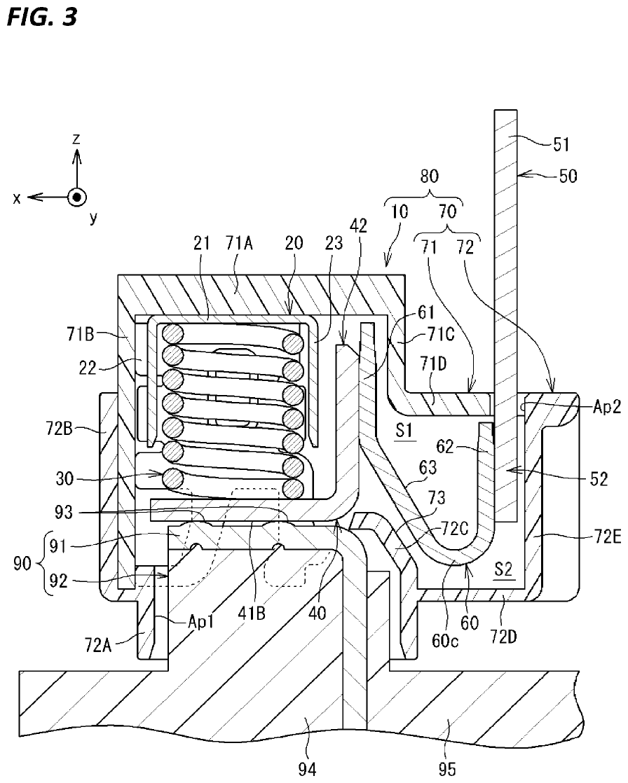

FIG. 1 is a cross-sectional view schematically depicting a connector 80 and a mating connector 90 according to the present embodiment before a mating operation. For the connector 80, the state before mating with the mating connector 90 is referred to as the “unmated state”. FIG. 2 is a cross-sectional view schematically depicting the connector 80 and the mating connector 90 during a mating operation. FIG. 3 is a cross-sectional view schematically depicting the connector 80 and the mating connector 90 after mating. For the connector 80, the state after mating with the mating connector 90 is referred to as the “mated state”.

In the following description, the direction in which the mating connector 90 is attached to and detached from the connector 80 is referred to as the “vertical direction (or the “first direction” for the present disclosure) and is indicated as the “z direction” in the drawings. The side on which the mating connector 90 is attached to the connector 80 is the “upper side” (which is the positive side in the z direction and is referred to as the “second side” for the present disclosure). For the connector 80, a direction that is perpendicular to the vertical direction and in which a first terminal 40, a second terminal 50, and a flexible conductor 60, which will be described later, are aligned is referred to as the “front-rear direction” (or “second direction” for the present disclosure), and is indicated as the “x direction” in the drawings. The side on which the first terminal 40 is positioned with respect to the second terminal 50 and the flexible conductor 60 is the “front side” (which is the positive side in the x direction). A direction that is perpendicular to the vertical direction and the front-rear direction is referred to as the “left-right direction”, and is indicated as the “y direction” in the drawings. The side that is on the left when facing forward is referred to as the “left side” (which is the positive side in the y direction). Note that the directions mentioned here are relative directions used to describe the configuration of the connector 80 and the like, and do not refer to actual direction when the connector 80 is attached to a device.

The connector 80 and the mating connector 90 are respectively provided on devices installed in an automobile. As one example, the connector 80 is provided on a PCU (which is one example of a “device”) including an inverter circuit, and the mating connector 90 is provided on a motor (which is one example of a “mating device”). By inserting the mating connector 90 into the connector 80 as depicted in FIG. 3 after following the states depicted in FIGS. 1 and 2, the connector 80 and the mating connector 90 are mated, which results in the PCU and the motor being electrically connected. The mating of the connector 80 and the mating connector 90 will be described later.

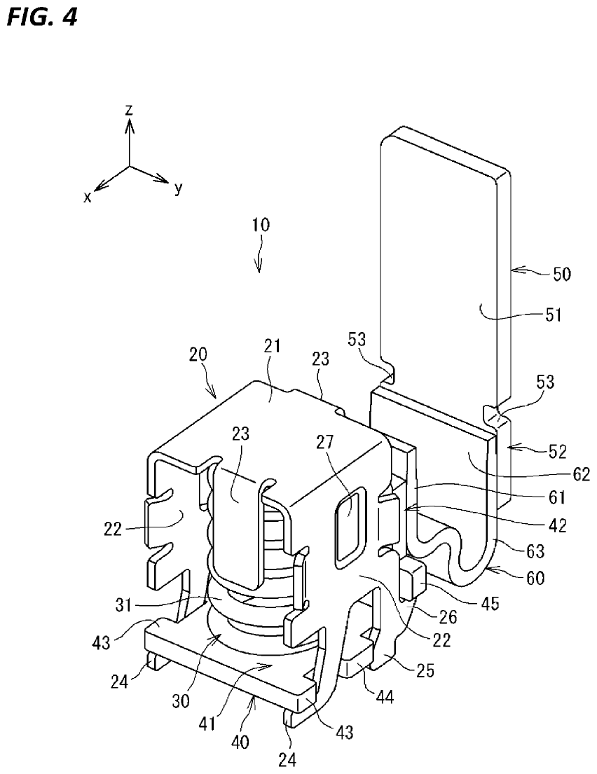

The connector 80 includes a terminal module 10 and a housing 70. Hereinafter, the terminal module 10 will be described by referring as appropriate to FIG. 4 to FIG. 9, and the housing 70 will be described with reference to FIG. 1.

Configuration of Terminal Module

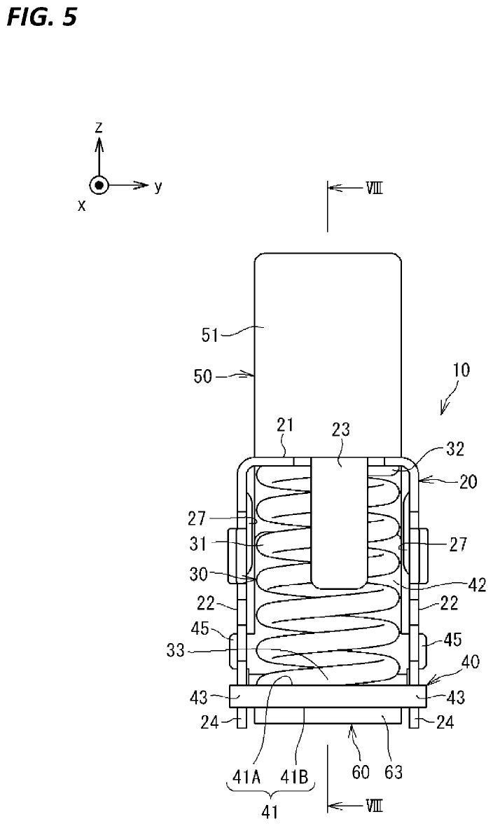

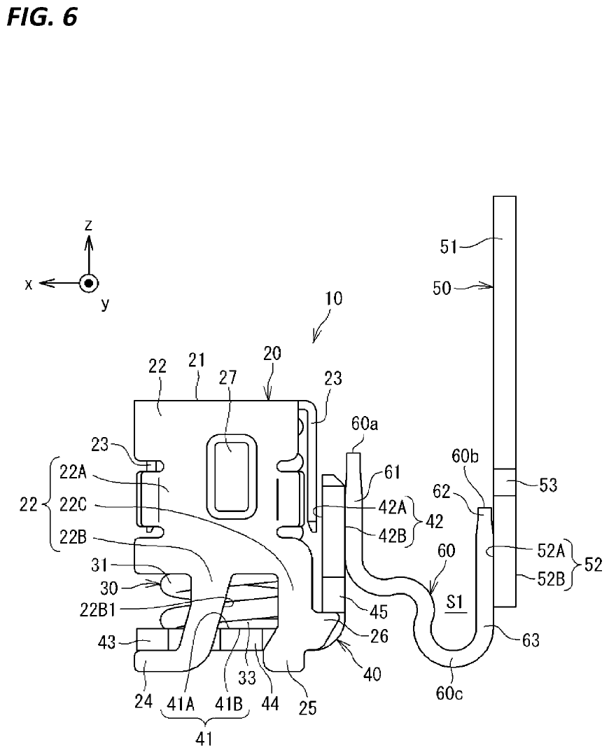

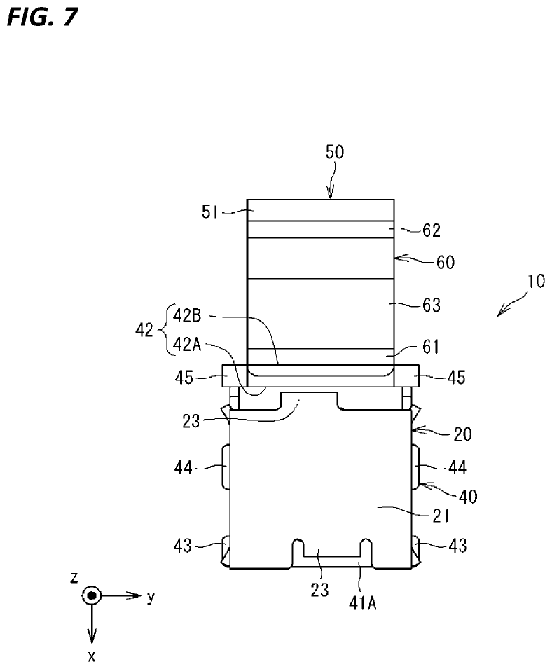

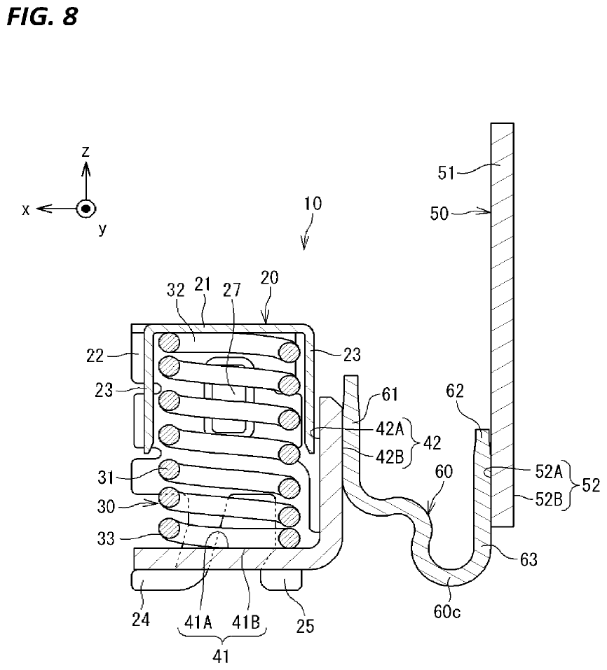

FIG. 4 is a perspective view of the terminal module 10 according to the present embodiment when looking diagonally from upper left. FIG. 5 is a front view of the terminal module 10 when looking from the front. FIG. 6 is a side view of the terminal module 10 when looking from the left. FIG. 7 is a plan view of the terminal module 10 when looking from above. FIG. 8 is a cross-sectional view of the terminal module 10 that has been cut along a cutting line indicated by arrow VIII in FIG. 5. FIGS. 1, 2 and 3 depict the connector 80 and the mating connector 90 using the same cross section as FIG. 8.

The terminal module 10 is a module for electrically connecting a mating terminal 91 (see FIG. 1) included in the mating connector 90 and an electric circuit (not illustrated) included in the device. The terminal module 10 is equipped with a case 20, an elastic member 30, the first terminal 40, the second terminal 50, and the flexible conductor 60. The configuration of each part of the terminal module 10 described below refers to the configuration of the connector 80 in the unmated state (that is, the state depicted in FIG. 1).

The case 20 includes a ceiling wall 21, a pair of left and right side walls 22, 22, and a pair of front and rear side walls 23, 23. The case 20 is made of metal (as one example, stainless steel), and the ceiling wall 21, the side walls 22, 22 and the side walls 23, 23 are integrally formed by pressing a plate material. The ceiling wall 21 is a region in the form of a flat plate that extends in the front-rear and left-right directions. The widths of the ceiling wall 21 in the front-rear and left-right directions are larger than the widths in the front-rear and left-right directions of the elastic member 30, so that when looking from above as in FIG. 7, the elastic member 30 is entirely covered by the ceiling wall 21.

The pair of side walls 22, 22 are a pair of parallel walls that extend downward from the left and right edges of the ceiling wall 21. Since the pair of side walls 22, 22 have shapes that exhibit mirror symmetry, the left side wall 22 will be described below as a representative. As depicted in FIG. 6, the side wall 22 includes a base portion 22A, a first leg portion 22B, and a second leg portion 22C.

The base portion 22A is a region that is continuous with the ceiling wall 21. The base portion 22A has the same width as the ceiling wall 21 in the front-rear direction. The base portion 22A includes a protruding portion 27 that protrudes rightward (that is, inward in the left-right direction). As depicted in FIG. 5, an inner surface in the left-right direction of the protruding portion 27 opposes a side portion in the left-right direction of the elastic member 30 with a slight gap in between. The protruding portion 27 has a function of receiving the elastic member 30 that bends in the left-right direction when the elastic member 30 is compressed or extended.

The first leg portion 22B is a region that extends downward from the base portion 22A and diagonally toward the front in the center part in the front-rear direction of the base portion 22A. The width of the first leg portion 22B in the vertical direction is larger than the inclined width in the front-rear direction. The first leg portion 22B has a width in the front-rear direction that is smaller than the width of the base portion 22A (in more detail, a width that is around a quarter of the width of the base portion 22A).

The rear side surface of the first leg portion 22B functions as a guide surface 22B1 for guiding a guided portion 44, described later, when the mating connector 90 is mated. Since the guide surface 22B1 extends downward while being inclined in the front-rear direction, the guided portion 44 is guided along the guide surface 22B1 not only in the vertical direction but also in the front-rear direction. The first leg portion 22B includes a first receiver portion 24 that extends forward at the lower end of the first leg portion 22B. An upper surface of the first receiver portion 24 is a surface that extends along the front-rear direction, and is capable of receiving a first engaging portion 43, described later, included in the first terminal 40.

The second leg portion 22C is a region that extends downward from the base portion 22A at the bottom and rear side of the base portion 22A. The second leg portion 22C is positioned behind the first leg portion 22B, and the first leg portion 22B and the second leg portion 22C are separated in the front-rear direction. The guided portion 44, described later, included in the first terminal 40 is inserted between the first leg portion 22B and the second leg portion 22C. The second leg portion 22C has a smaller width in the front-rear direction than the base portion 22A (in more detail, a width of around a quarter of the width of the base portion 22A). The second leg portion 22C includes a lower end portion 25 and a second receiver portion 26 that protrudes to the rear above the lower end portion 25. An upper surface of the second receiver portion 26 is a surface that extends in the front-rear direction, and is capable of receiving a second engaging portion 45, described later, included in the first terminal 40.

The pair of side walls 23, 23 are a pair of parallel walls that extend downward from edges at the front and rear of the ceiling wall 21. The pair of side walls 23, 23 have a smaller width in the left-right direction than the width of the ceiling wall 21 (in more detail, around one third of the width of the ceiling wall 21). The pair of side walls 23, 23 also have a smaller width in the vertical direction than the side walls 22 (in more detail, around half the width of the side wall 22). As depicted in FIG. 8, the inner surfaces of the pair of side walls 23, 23 in the front-rear direction oppose side portions in the front-rear direction of the elastic member 30 with a slight gap in between. The pair of side walls 23, 23 have a function of receiving the elastic member 30 that bends in the front-rear direction when the elastic member 30 is compressed or extended.

The elastic member 30 is a coil spring produced by winding metal wire (made of stainless steel, for example) into a coil. Note that the elastic member 30 may be a member aside from a coil spring so long as the member is capable of extending and contracting in the vertical direction and also tilting in the front-rear direction. As examples, the elastic member 30 may be a different spring member (as one example, a leaf spring) or a rubber member.

The elastic member 30 is housed in the case 20. That is, the elastic member 30 is housed in a space that is surrounded by the ceiling wall 21, the pair of side walls 22, 22, and the pair of side walls 23, 23, and is open at the bottom. The elastic member 30 is sandwiched between the ceiling wall 21 and a first part 41, described later, included in the first terminal 40 so as to be compressed in the vertical direction. In this state, the elastic member 30 is capable of being further compressed in the vertical direction. That is, the elastic member 30 is compressed by the ceiling wall 21 and the first part 41 within a range that is shorter than the free length of the spring but longer than the solid length.

As depicted in FIG. 8, the elastic member 30 includes a body portion 31, an upper end portion 32, and a lower end portion 33. The upper end portion 32 is a region of around one turn from the upper end of the elastic member 30 and is in contact with the ceiling wall 21. The lower end portion 33 is a region of about one turn from the lower end of the elastic member 30 and is in contact with the first portion 41. The body portion 31 is a region located between the upper end portion 32 and the lower end portion 33.

The first terminal 40 is a terminal that can physically contact the mating terminal 91 and is attached to the pair of side walls 22, 22. The first terminal 40 includes the first part 41 and a second part 42. The first terminal 40 is made of metal (for example, copper alloy), and the first part 41 and the second part 42 are integrally formed by pressing a plate material. The first part 41 is provided in parallel with the ceiling wall 21 (that is, along the front-rear and left-right directions) and is separated below the ceiling wall 21. The second part 42 is a region that extends upward from the rear edge of the first part 41. This means that the first terminal 40 is L shaped when viewed from the side as depicted in FIG. 6 (or when viewed in a cross section from the side, as depicted in FIG. 8).

An upper surface 41A of the first part 41 functions as a receiver surface for receiving the lower end portion 33 of the elastic member 30. A lower surface 41B of the first part 41 functions as a contact surface capable of contacting the mating contact 93 included in the mating terminal 91.

As depicted in FIG. 4 and FIG. 7, the first portion 41 includes a pair of left and right first engaging portions 43, 43 and a pair of left and right guided portions 44, 44. The first engaging portions 43 are regions that protrude outward in the left-right direction at the front edge of the first part 41, and contact the first receiver portions 24 of the first leg portions 22B in the vertical direction. Each guided portion 44 is a region that protrudes outward in the left-right direction at the central part in the front-rear direction of the first part 41, and is inserted into the gap between the first leg portion 22B and the second leg portion 22C.

As depicted in FIG. 6, a front surface 42A of the second part 42 faces toward the elastic member 30, and opposes the side wall 23 on the rear side with a slight gap in the front-rear direction. A rear surface 42B (or “first surface” for the present disclosure) of the second part 42 is a surface that faces in the opposite direction to the elastic member 30, and opposes a front surface 52A (or “second surface” for the present disclosure, described later) included in the second terminal 50 in the front-rear direction. In other words, at least part of the rear surface 42B is positioned so as to overlap with the front surface 52A in the vertical direction. The flexible conductor 60 is connected to this rear surface 42B.

As depicted in FIG. 4 and FIG. 5, the second part 42 includes a pair of left and right second engaging portions 45, 45. Each second engaging portion 45 is a region that protrudes outward in the left-right direction slightly below the center part in the vertical direction of the second part 42, and contacts a second receiver portion 26 of a second leg portion 22C in the vertical direction.

The first terminal 40 is downwardly biased by the elastic member 30. Due to the first engaging portions 43 contacting the first receiver portions 24 and the second engaging portions 45 contacting the second receiver portions 26, downward movement of the first terminal 40 is restricted. That is, in the unmated state, the first terminal 40 is sandwiched between the elastic member 30 and the pair of side walls 22, 22 (in more detail, the pair of first receiver portions 24, 24 and the pair of second receiver portions 26, 26).

The second terminal 50 is a flat terminal that is electrically connected to an electric circuit (not illustrated) included in the PCU, and is attached to the housing 70, described later. The second terminal 50 includes an upper part 51, a lower part 52, and a waist part 53. The second terminal 50 is made of metal (for example, copper alloy), and the upper part 51, the lower part 52, and the waist part 53 are integrally formed by pressing a plate material.

As depicted in FIG. 1, the upper part 51 is a region provided outside the housing 70 and is connected to an electric circuit (not depicted). The lower part 52 is a region that extends downward from the upper part 51 and is provided inside the housing 70. As depicted in FIG. 6, the front surface 52A of the lower part 52 faces toward the elastic member 30 and the second part 42. The flexible conductor 60 is connected to the front surface 52A. A rear surface 52B of the lower part 52 opposes the housing 70 (FIG. 1) with a slight gap in the front-rear direction. The waist part 53 is a region that is inwardly recessed in the left-right direction at a boundary region between the upper part 51 and the lower part 52, and is provided in an opening Ap2, described later, that is formed in the housing 70.

The flexible conductor 60 is a conductor that is flexible and electrically connects the first terminal 40 and the second terminal 50. In the present embodiment, the flexible conductor 60 is a braided wire in the form of a strip that is produced by weaving a plurality of conductive metal wires (as one example, copper wires). Note that there are no particular limitations on the flexible conductor 60 as long as it is a conductor and is flexible. As one example, the flexible conductor 60 may be a tubular braided wire, or may be a coated wire produced by covering conductive twisted wire with an insulator.

The flexible conductor 60 includes a first joint portion 61 that is connected to the first terminal 40, a second joint portion 62 that is connected to the second terminal 50, and an intermediate part 63 that is positioned between the first joint portion 61 and the second joint portion 62.

In more detail, as depicted in FIG. 6, the first joint portion 61 is connected to the rear surface 42B of the first terminal 40 in a state where an end portion 60a of the flexible conductor 60 faces upward and the intermediate part 63 faces downward. The second joint portion 62 is connected to the front surface 52A of the second terminal 50 in a state where an end portion 60b (that is, an end portion at the opposite end to the end portion 60a) of the flexible conductor 60 faces upward and the intermediate part 63 faces downward. The first joint portion 61 and the second joint portion 62 are resistance welded or crimped to the rear surface 42B and the front surface 52A, respectively, and have higher rigidity than the intermediate part 63.

The second part 42 of the first terminal 40 and the lower part 52 of the second terminal 50 oppose each other in the front-rear direction (that is, a direction that is perpendicular to the vertical direction). The first joint portion 61 and the second joint portion 62 are also aligned in the front-rear direction while being sandwiched in the front-rear direction between the second part 42 and the lower part 52.

The intermediate part 63 is longer than the straight-line distance between the first joint portion 61 and the second joint portion 62, and flexes in a state of protruding downward (that is, the intermediate part 63 is substantially U shaped when viewed from the side). A top portion 60c of a curve traced by the flexible conductor 60 (in FIG. 6, a part corresponding to a minimum on the curve traced by the flexible conductor 60) is located at an intermediate position on the intermediate part 63. In the unmated state, a space that is surrounded by the flexible conductor 60 and open at the top is referred to as the “space S1”. The space S1 functions as a range of movement into which part of the flexible conductor 60 including the top portion 60c advances when the mating connector 90 is mated.

Construction of the Housing

The following description refers to FIG. 1. The housing 70 is a member made of resin that houses the terminal module 10. The housing 70 is a member divided into upper and lower parts and includes an upper split body 71 and a lower split body 72. The upper split body 71 is a housing with an open bottom, and has an upper wall 71A, a front wall 71B, a rear wall 71C, and a rear-side upper wall 71D. The parts 71A to 71D of the upper split body 71 are integrally formed by injection molding, for example.

The upper wall 71A is a wall that contacts the ceiling wall 21 in the vertical direction, and is provided along the front-rear and left-right directions. The front wall 71B is a wall that contacts the pair of side walls 22, 22 in the front-rear direction, and extends downward from the front edge of the upper wall 71A. The lower end of the front wall 71B is positioned lower than the lower surface 41B of the first terminal 40.

The rear wall 71C is a wall that extends downward from the rear edge of the upper wall 71A. An edge on the rear side of the upper wall 71A and the rear wall 71C are located to the rear of the first joint portion 61. The lower end of the rear wall 71C is at a position that overlaps with the waist part 53 in the vertical direction. In addition, the lower end of the rear wall 71C is at substantially the same position in the vertical direction as the upper end of the second part 42 and the first joint portion 61. This means that a space S2 surrounded by the upper wall 71A, the rear wall 71C, and the case 20 (in more detail, the rear side wall 23) is formed above the second part 42 and the first joint portion 61.

The rear-side upper wall 71D is a wall that extends rearward from the lower end of the rear wall 71C. A rear end of the rear-side upper wall 71D and a rear wall 72E, described later, included in the lower split body 72 form an opening Ap2 that is open in the vertical direction. The second terminal 50 is inserted into the housing 70 through this opening Ap2. The second terminal 50 is fixed to the housing 70 with the waist portion 53 positioned in the opening Ap2 and the upper portion 51 and the lower portion 52 sandwiching parts of the rear-side upper wall 71D positioned to the left and right of the opening Ap2.

The lower split body 72 is a tubular body that has an opening Ap1 formed in the vertical direction and configures the housing 70 in combination with the upper split body 71. The lower split body 72 includes a tubular portion 72A, a front wall 72B, an inclined wall 72C, a lower wall 72D, and a rear wall 72E. These parts 72A to 72E of the lower split body 72 are integrally formed by injection molding, for example.

The tubular portion 72A is a square tube-shaped region provided at a lower part of the lower split body 72. The tubular portion 72A forms the opening Ap1 that allows the mating connector 90 to enter from below. The inner dimensions of the tubular portion 72A are formed larger than the outer dimensions of the mating terminal 91 and a mating portion 94, described later, included in the mating connector 90, which enables the mating terminal 91 and the mating portion 94 to enter the tubular portion 72A.

An upper end of the tubular portion 72A contacts the lower surface 41B of the first terminal 40. As a result, the terminal module 10 is held inside the housing 70 in a state of being vertically sandwiched between the upper wall 71A and an upper end of the tubular portion 72A. The lower surface 41B of the first terminal 40 is exposed to the lower side of the connector 80 through the opening Ap1. The width in the front-rear direction of the tubular portion 72A is larger than the width in the front-rear direction of the first terminal 40, and the rear end of the tubular portion 72A is positioned to the rear of the second portion 42.

The front wall 72B is a wall that protrudes forward from an intermediate position in the vertical direction of the tubular portion 72A and then extends upward. The front wall 71B of the upper split body 71 contacts the rear side of the front wall 72B, and the lower end of the front wall 71B is inserted into a gap formed between the front wall 72B and the tubular portion 72A.

The inclined wall 72C is a wall that connects to the rear upper end of the cylindrical portion 72A and extends upward in a state that is inclined toward the front. When the mating connector 90 is mated, the inclined wall 72C has a function as a partition between the space into which the mating connector 90 advances and the space in which the flexible conductor is positioned. The inclined wall 72C has an inclined surface 73 that opposes the flexible conductor 60. The inclined surface 73 is a surface that is positioned closer to the first joint portion 61 than the top portion 60c of the flexible conductor 60, and is a surface that approaches the first joint portion 61 in the upward direction.

The lower wall 72D is a wall that extends rearward from an intermediate position in the vertical direction of the cylindrical portion 72A. The lower wall 72D is positioned below the top portion 60c of the flexible conductor 60. The lower wall 72D extends further rearward than the second terminal 50. The rear wall 72E is a wall that extends upward from the rear end of the lower wall 72D. The upper end of the rear wall 72E is at the same position in the vertical direction as the rear-side upper wall 71D. The rear wall 72E opposes the lower part 52 of the second terminal 50 with a slight gap in the front-rear direction. The opening Ap2 described earlier is formed by the rear wall 72E and the rear-side upper wall 71D.

Configuration of Mating Connector

The mating connector 90 includes the mating terminal 91 and a mating housing 92. The mating terminal 91 is provided on the mating housing 92 by insert molding. The mating terminal 91 is a conductive metal member (made of copper alloy, for example), and is L-shaped including a region that extends vertically and a region that extends forward from the vertical region. The mating terminal 91 includes mating contacts 93 that contact the lower surface 41B of the first terminal 40. The mating contacts 93 are provided in bead shapes on the upper surface of the mating terminal 91 by causing plastic deformation of parts of the mating terminal 91.

The mating housing 92 is a member made of resin. The mating housing 92 includes the mating portion 94 that is capable of advancing into the opening Ap1 and a flange portion 95 that extends in the front-rear and left-right directions. The mating portion 94 has an upwardly protruded shape, and supports the mating terminal 91 on its upper surface. The flange portion 95 is larger than the opening Ap1 in the front-rear and left-right directions, and in the mated state depicted in FIG. 3, the flange portion 95 contacts the lower end of the tubular portion 72A included in the housing 70, which prevents the mating connector 90 from advancing into the connector 80 beyond a predetermined position.

Mating of Connector and Mating Connector

Mating of the mating connector 90 into the connector 80 will now be described with reference to FIGS. 1 to 3. As depicted in FIGS. 1 and 2, when the mating connector 90 moves upward and approaches the connector 80, the mating terminal 91 and the mating portion 94 of the mating connector 90 advance into the housing 70 through the opening Ap1. The mating contacts 93 of the mating terminal 91 then contact the lower surface 41B of the first terminal 40. Note that when the connector 80 is mated with the mating connector 90, the connector 80 and the mating connector 90 may move relative to each other in the vertical direction, or the connector 80 may move downward to approach the mating connector 90.

If, after the mating contacts 93 have contacted the lower surface 41B, the mating connector 90 moves further upward, the first terminal 40 is pressed by the mating contacts 93 and moves upward while compressing the elastic member 30. At this time, the guided portions 44 of the first terminal 40 slide on the guide surfaces 22B1 of the first leg portions 22B, so that the first terminal 40 moves upward as indicated by an arrow AR1 (FIG. 2) and also to the rear in keeping with the inclination in the front-rear direction of the surface 22B1. Since the width in the vertical direction of the guide surface 22B1 is larger than the inclined width in the front-rear direction, the upward movement of the first terminal 40 during mating is greater than the rearward movement.

The lower surface 41B of the first terminal 40 that moves rearward comes into sliding contact in the front-rear direction with the mating contacts 93 that move upward. By doing so, any foreign matter (as one example, a film of sulfide, oxide, or the like formed on the lower surface 41B) that adheres between the lower surface 41B and the mating contacts 93 is removed.

After this, when the mating connector 90 moves further upward as depicted in FIG. 3, the mating connector 90 mates with the connector 80. In this state, the first part 41 of the first terminal 40 receives a downward biasing force from the elastic member 30, and is sandwiched in the vertical direction between the elastic member 30 and the mating contacts 93 while receiving an upward pressing force from the mating contacts 93. In this way, by pressing the first part 41 against the mating contacts 93 with the elastic member 30, the first terminal 40 can be electrically connected to the mating contacts 93 more reliably.

### Effects of the Present Embodiment

During mating, the first terminal 40 moves upward relative to the second terminal 50. Together with this, part of the flexible conductor 60 (in more detail, the top portion 60c and the part that is closer to the first joint portion than the top portion 60c) also moves upward. The intermediate part 63 of the flexible conductor 60 flexes in a downwardly protruding shape. This means that the direction (upward) in which a part of the flexible conductor 60 moves during mating is the opposite direction to the direction (downward) in which the intermediate part 63 of the flexible conductor 60 protrudes.

As a result, the range of movement of the flexible conductor 60 can be constrained to within the space S1 that is surrounded by the flexible conductor 60 before mating. In other words, during mating, the flexible conductor 60 moves so as to advance into the space S1 that is surrounded by the flexible conductor 60 before mating. This makes it possible to reduce the space provided with respect to the range of movement of the flexible conductor 60. As a result, it is possible to downsize the connector while suppressing disconnection of the flexible conductor.

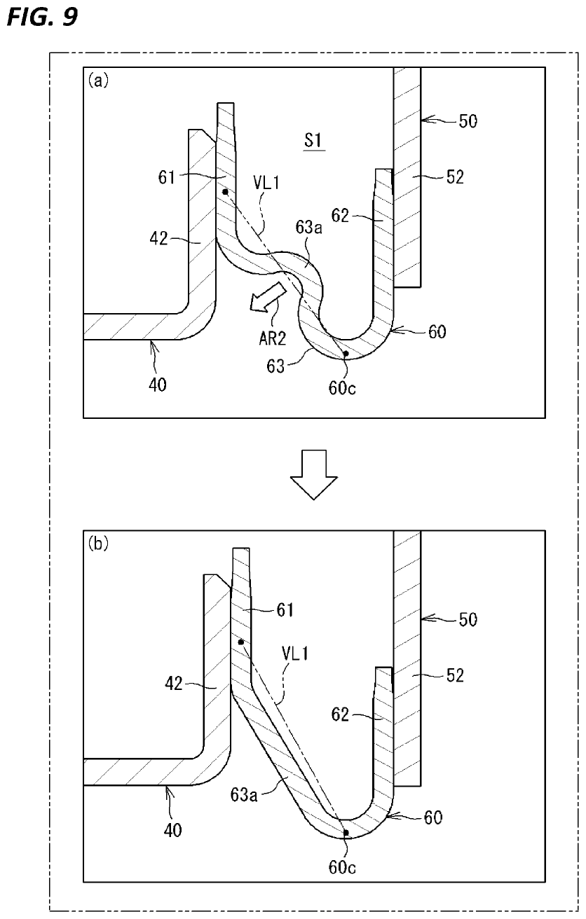

FIG. 9 is a diagram schematically depicting the state of the flexible conductor 60 before and after mating. (a) in FIG. 9 depicts the flexible conductor 60 before mating, and (b) in FIG. 9 depicts the flexible conductor 60 after mating.

The flexible conductor 60 is flexed before the connector 80 and the mating connector 90 are mated, and when the mating connector 90 is mated with the connector 80, the flexible conductor 60 extends upward in keeping with the movement of the first terminal 40 so as to eliminate the flexing of the flexible conductor 60.

In more detail, the intermediate part 63 flexes before mating so that a part 63a of the intermediate part 63 is positioned on the second joint portion 62 side of a virtual line VL1 that connects the first joint portion 61 and the top portion 60c. That is, the intermediate member 63 flexes so that this part 63a is bent toward the inside of the U-shape traced by the flexible conductor 60. During mating, the portion 63a of the intermediate part 63 extends so as to move as indicated by the arrow AR2 from the second joint portion 62 side of the virtual line VL1 to the opposite side to the second joint portion 62.

The intermediate part 63 flexes before mating so that the portion 63a is bent toward the inside of the U shape. This means that the space provided inside the housing 70 for housing the flexible conductor 60 before mating can be made smaller. Since this bent portion 63a extends during mating, it is possible to suppress swinging of the flexible conductor 60 during mating, which makes it possible to suppress the flexible conductor 60 rubbing against the housing 70.

Here, in the background art (for example, Patent Document 1), the flexible conductor is extended before the connector is mated with the mating connector, which results in the flexible conductor flexing when the mating connector is mated with the connector. That is, the flexible conductor that was extended flexes due to the mating. This produces the risk of the flexible conductor flexing so as to rub against the housing or the like during mating with the mating connector, which can cause disconnection.

On the other hand, the flexible conductor 60 in the present embodiment is already flexed before the connector 80 and the mating connector 90 are mated. Since the connector 80 in an unmated state is in the manufactured state (which is to say, the initial state), by assembling the flexible conductor 60 on the connector 80 in a state where the flexible conductor 60 is caused to flex without rubbing against the housing 70, it is possible to suppress rubbing of the conductor 60 against the housing 70. The flexible conductor 60 also extends (that is, the flexing is reduced) when the mating connector 90 mates with the connector 80. This makes it possible to suppress swinging of the flexible conductor 60 when the mating connector 90 is mated, and thereby suppress rubbing of the flexible conductor 60 against the housing 70 during mating.

That is, according to the present embodiment, the flexible conductor 60, which is flexed in the unmated state, becomes extended due to the mating, which means that the behavior of the flexible conductor 60 during mating becomes easier to predict than in the past. As a result, the space provided in the housing 70 with respect to the range of movement of the flexible conductor 60 can be made smaller. This makes it possible to reduce the size of the connector 80 while suppressing disconnection of the flexible conductor 60.

The flexible conductor 60 is positioned between the first terminal 40 and the second terminal 50 in the front-rear direction. This makes it possible to prevent the flexible conductor 60 from contacting the housing 70 more reliably. In particular, since the second joint portion 62 is connected to the front surface 52A of the lower part 52, it is possible to prevent the flexible conductor 60 from contacting the rear wall 72E of the housing 70 more reliably.

Here, since the lower end of the lower part 52 has a corner, if the flexible conductor 60 were to rub against this location, there would be the risk of abrasion of the flexible conductor 60. In the present embodiment, the second joint portion 62 is connected to the front surface 52A of the lower part 52, and the intermediate part 63 is provided so as to curve toward the front from the second joint portion 62, which makes it possible to suppress rubbing of the flexible conductor 60 on the lower end of the lower part 52.

In addition, at least part of the rear surface 42B is positioned so as to overlap with the front surface 52A in the vertical direction. By doing so, the space required to house the flexible conductor 60 connected to the rear surface 42B and the front surface 52A can be reduced in the vertical direction, which makes it possible to downsize the housing 70 in the vertical direction.

The rear surface 42B of the first terminal 40 and the front surface 52A of the second terminal 50 oppose each other in the front-rear direction. During mating, the rear surface 42B moves upward while also moving rearward to approach the front surface 52A. As the rear surface 42B and the front surface 52A approach each other in the front-rear direction, the top portion 60c of the flexible conductor 60 moves downward. Also, when the rear surface 42B moves upward, the top portion 60c moves upward. In the present embodiment, since the amount of upward movement of the first terminal 40 is larger than the amount of rearward movement, as depicted in FIG. 2 and FIG. 3, the net result is the top portion 60c moving upward (that is, is the direction away from the lower wall 72D) due to the mating.

In this way, by making the amount of upward movement of the first terminal 40 larger than the amount of rearward movement thereof, during mating, part of the flexible conductor 60 including the top portion 60c will advance inside of the U-shaped space S1 formed by the flexible conductor 60 in the unmated state. As a result, since the range of movement of the flexible conductor 60 can be accommodated in this space S1, it is possible to downsize the connector 80 while suppressing rubbing of the flexible conductor 60 against the housing 70 during mating.

Also, in the mated state, the second part 42 of the first terminal 40 and the first joint portion 61 of the flexible conductor 60 advance into the space S2. This space S2 is originally provided as the range of movement of the first terminal 40. In the present embodiment, by using the space S2 as the range of movement of the first terminal 40 and also as the range of movement of the flexible conductor 60, it is possible to downsize the connector 80.

The flexible conductor 60 according to the present embodiment is configured to extend during mating, which suppresses contact between the flexible conductor 60 and the housing 70 during mating. On the other hand, the flexible conductor 60 will flex when the mating connector 90 is removed from the connector 80. However, compared to the conventional configuration where the flexible conductor is assembled in the terminal module in an extended state and flexes during mating in keeping with the depth of insertion of the mating connector 90, since the flexible conductor 60 in the present embodiment is assembled on the terminal module 10 in already flexed state, it is relatively easy to predict how the flexible conductor 60 will flex when the mating connector 90 is removed. As a result, it is possible to provide an appropriate range of movement for the flexible conductor 60 in the housing 70, which makes it possible to suppress rubbing of the flexible conductor 60 against unintended parts of the housing 70.

Here, to prevent abrasion of the flexible conductor 60, it is important to avoid rubbing of the flexible conductor 60 on the angular parts of the housing 70 and the application of excessive force on the flexible conductor 60 due to the housing 70 contacting the flexible conductor 60 so as to prevent flexing of the flexible conductor 60. On the other hand, if there is low risk of abrasion of the flexible conductor 60, the flexible conductor 60 may be intentionally placed in contact with the housing 70. Since it is preferable to reduce the space inside the housing 70 provided as the range of movement of the flexible conductor 60 in order to downsize the connector 80, it is possible to use a configuration where the housing is located at positions just within the range of movement of the flexible conductor 60 and the flexible conductor 60 flexes in the unmated state so as to softly contact the housing 70.

Since the inclined surface 73 in the present embodiment is inclined in the same direction as the direction in which the intermediate part 63 is inclined toward the first joint portion 61, it is possible to suppress contact between inner surfaces of the housing 70 and the flexible conductor 60. Even when the flexible conductor 60 and the inclined surface 73 come into contact, since the inclined surface 73 is a surface that follows the inclined direction of the intermediate member 63, abrasion of the flexible conductor 60 when contact is made can be suppressed.

In addition, the inclined surface 73 of the housing 70 in the present embodiment contacts the flexible conductor 60 when the flexible conductor 60 transitions from the extended state to the flexed state, thereby regulating the flexed shape of the flexible conductor 60.

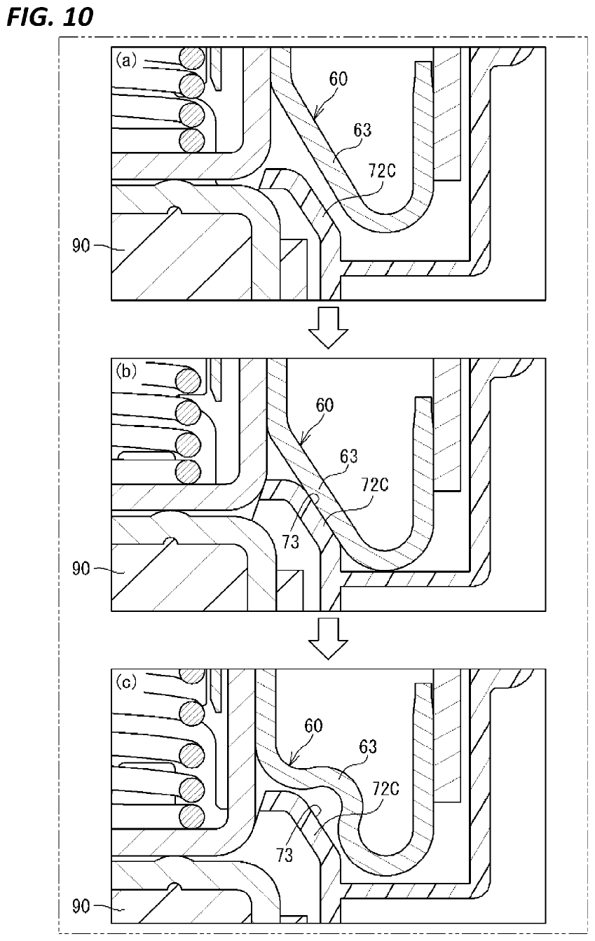

FIG. 10 is a diagram schematically depicting the state of the flexible conductor 60 when the mating connector 90 is removed from the connector 80. (a) in FIG. 10 depicts the flexible conductor 60 in the mated state, and (b) in FIG. 10 depicts the flexible conductor 60 when the mating connector 90 is in the process of being removed. (c) in FIG. 10 depicts the flexible conductor 60 in the unmated state. As depicted in (a) and (b) in FIG. 10, when the mating connector 90 is removed, the first terminal 40 moves diagonally downward toward the front, with the flexible conductor 60 also moving in keeping with such movement. At this time, the flexible conductor 60 moves while maintaining its shape in the extended state to a certain degree. That is, the intermediate part 63 moves down while remaining in an extended state.

After this, as depicted in (b) and (c) in FIG. 10, the intermediate part 63 contacts the inclined surface 73 and flexes so as to bend inside the U shape (that is, toward the space S1). Since the inclined surface 73 contacts the intermediate part 63 in a substantially parallel state, the flexible conductor 60 is guided to the inside of the U-shape while suppressing abrasion of the flexible conductor 60 when contact is made, which makes it possible to regulate the flexed shape of the flexible conductor 60. By doing so, the flexible conductor 60 can be prevented from flexing into an unintended shape, and the flexible conductor 60 can be prevented from rubbing against an unintended part of the housing 70.

### Modifications

Modifications to the present embodiment will now be described. In these modifications, the same reference numerals have been assigned to parts that are unchanged from the embodiment and description thereof is omitted.

Modification of First Terminal

In the embodiment described above, the first terminal 40 includes the first part 41 that is parallel to the ceiling wall 21 and the second part 42 that extends upward from the rear end of the first part 41. However, the direction in which the second part 42 extends is not limited to this.

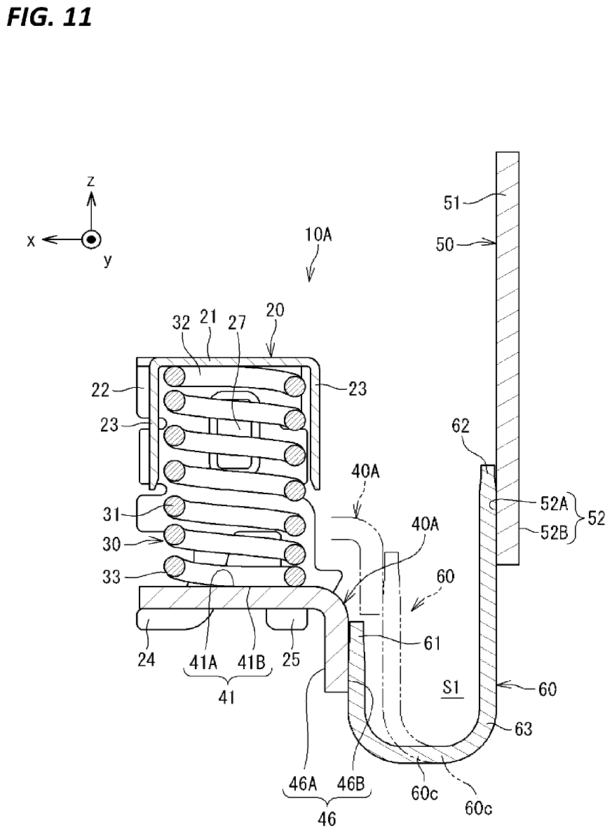

FIG. 11 is a cross-sectional view schematically depicting a terminal module 10A according to a modification. In FIG. 11, the terminal module 10A in the unmated state is indicated by a solid line. The terminal module 10A differs from the first terminal 40 according to the above embodiment in the shape of the first terminal 40A, and the other features are the same as the embodiment described above.

The first terminal 40A includes the first part 41 and a second part 46. The second part 46 is a region that extends downward from the rear end of the first part 41. The first joint portion 61 of the flexible conductor 60 is connected to a rear surface 46B of this second part 46. The rear surface 46B is a surface that faces in the opposite direction to the elastic member 30. The rear surface 46B is a surface that is parallel to the front surface 52A of the second terminal 50 and is positioned below the front surface 52A. That is, the rear surface 46B diagonally faces the front surface 52A. Note that the first joint portion 61 of the flexible conductor 60 may be connected to the front surface 46A of the second part 46.

The positions of the first terminal 40A and the flexible conductor 60 in the mated state are indicated by chain double-dashed lines in FIG. 11. When the mating connector 90 is mated, the first terminal 40A moves upward and to the rear like in the embodiment described above. Together with this, the first joint portion 61 and a first joint portion 61-side region of the intermediate part 63 move upward and rearward.

Like the embodiment described above, since the amount of upward movement of the first terminal 40 is greater than the amount of rearward movement, the top portion 60c moves upward due to the mating. For this reason, as depicted in FIG. 11, in the mated state, part of the flexible conductor 60 including the top portion 60c becomes located inside the U-shaped space S1 formed by the flexible conductor 60 in the unmated state. As a result, since the range of movement of the flexible conductor 60 can be accommodated in the space S1, it is possible to downsize the connector 80 while suppressing rubbing of the flexible conductor 60 against the housing 70 during mating.

Modification of Second Joint Portion

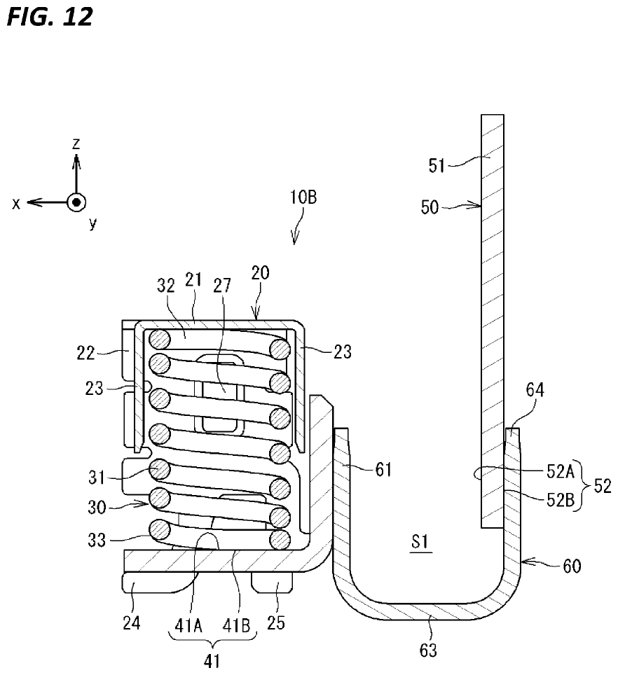

FIG. 12 is a cross-sectional view schematically depicting a terminal module 10B according to a modification. FIG. 12 depicts the terminal module 10B in the unmated state. The second joint portion 62 according to the embodiment described above is connected to the front surface 52A of the lower part 52 of the second terminal 50. On the other hand, a second joint portion 64 according to this modification is connected to the rear surface 52B of the lower part 52 of the second terminal 50.

By using this configuration, the distance in the front-rear direction between the first joint portion 61 and the second joint portion 64 becomes longer, so that a wider space S1 formed by the flexible conductor 60 can be provided. This means that even when the first terminal 40 moves by a larger amount during mating, the range of movement of the flexible conductor 60 can be accommodated in the space S1.

Modification for Regulating the Flexed Shape of the Flexible Conductor

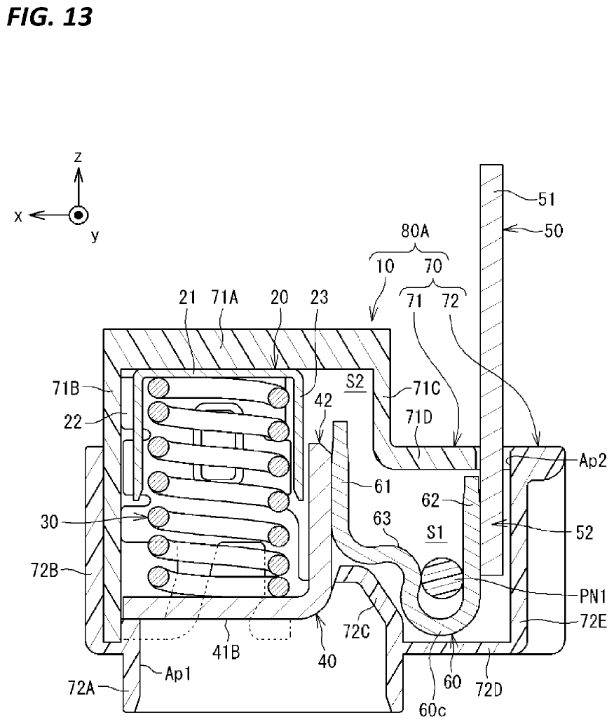

FIG. 13 is a cross-sectional view schematically depicting a connector 80A according to a modification. FIG. 13 depicts the connector 80A in the unmated state. In the embodiment described above, a technology that regulates the flexed shape of the flexible conductor 60 by placing the inclined surface 73 into contact with the flexible conductor 60 is described. In this modification, a guide portion PN1 that further regulates the flexed shape of the flexible conductor 60 will be described.

The flexible conductor 60 has a downwardly protruding shape, and the top portion 60c is located at the lowest point of the flexible conductor 60. Here, when the connector 80 has been subjected to vibration or the like, there is the risk of the flexible conductor 60 flexing so as to become recessed toward the inside of the U shape (that is, toward the space S1). If, due to such unpredictable flexing, the flexible conductor 60 forms an upwardly protruding shape where the top portion 60c is positioned between the first joint portion 61 and the second joint portion 62 in the front-rear direction (that is, the flexible conductor 60 becomes W shaped), there is the risk of disconnection of the flexible conductor 60 due for example to plastic deformation of the flexible conductor 60 caused by excessive bending of the intermediate part 63 relative to the first joint portion 61 and/or the top portion 60c contacting the rear-side upper wall 71D of the housing 70. For this reason, the connector 80A according to this modification further includes the guide portion PN1 for preventing the flexible conductor 60 from becoming W-shaped as described above.

The guide portion PN1 is a rod-shaped resin member that extends in the left-right direction, and as depicted in FIG. 13 is circular in cross section. The guide portion PN1 is provided on the upper split body 71, for example. In the cross section in FIG. 13, the guide part PN1 is positioned in the space S1. In more detail, the guide portion PN1 is positioned at a gap above the top portion 60c of the flexible conductor 60 in the unmated state, and contacts the intermediate part 63 including the apex portion 60c in the mated state. By doing so, the flexible conductor 60 can be prevented from protruding upwardly, and the flexible conductor 60 can maintain its downwardly protruding shape. Since the guide portion PN1 has a circular cross section, it is possible to suppress abrasion of the flexible conductor 60 when contact is made.

### Other Modifications

An example where the first terminal 40 moves diagonally upward and to the rear when the mating connector 90 is mated has been described in the above embodiment. However, it is not essential for the first terminal 40 to move to the rear during mating, and the first terminal 40 may move only upward. In this case, the guide surface 22B1 of the first leg portion 22B has a shape that extends directly downward, and the guided portion 44 is guided in only the vertical direction.

### APPENDIX

Note that the above embodiment and the respective modification can be freely combined, at least in part. Also, all features of the embodiments disclosed here are exemplary and should not be regarded as limitations on the present disclosure. The scope of the present disclosure is indicated by the range of the patent claims and is intended to include all changes within the meaning and scope of the patent claims and their equivalents.

### LIST OF REFERENCE NUMERALS

10 Terminal module
10A Terminal module
10B Terminal module
20 Case
21 Ceiling wall
22 Side wall
22A Base portion
22B First leg portion
22B1 Guide surface
22C Second leg portion
23 Side wall
24 First receiver portion
25 Lower end portion
26 Second receiver portion
27 Protruding portion
30 Elastic member
31 Body portion
32 Upper end portion
33 Lower end portion
40 First terminal
40A First terminal
41 First part
41A Upper surface
41B Lower surface
42 Second portion
42A Front surface
42B Rear surface (first surface)
43 First engaging portion
44 Guided portion
45 Second engaging portion
46 Second part
46A Front surface
46B Rear surface
50 Second terminal
51 Upper part
52 Lower part
53 Waist part
52A Front surface (second surface)
52B Rear surface
60 Flexible conductor
60a End portion
60b End portion
60c Top portion
61 First joint portion
62 Second joint portion
63 Intermediate part
63a Portion (of intermediate part)
64 Second joint portion
70 Housing
71 Upper split body
71A Upper wall
71B Front wall
71C Rear wall
71D Rear-side upper wall
72 Lower split body
72A Tubular portion
72B Front wall
72C Inclined portion
72D Lower wall
72E Rear wall
73 Inclined surface
80 Connector
80A Connector
90 Mating connector
91 Mating terminal
92 Mating housing
93 Mating contact
94 Mating portion
95 Flange portion
PN1 Guide portion
Ap1 Opening
Ap2 Opening
S1 Space
S2 Space
AR1 Arrow
AR2 Arrow
VL1 Virtual line

1. A terminal module for mating to a mating connector that relatively approaches the terminal module from a first side to a second side along a first direction and for electrically connecting to the mating connector,
the terminal module comprising:
a case including a ceiling wall and a pair of side walls that extend from the ceiling wall toward the first side;
an elastic member that extends from the ceiling wall toward the first side;
a first terminal that is supported on the pair of side walls in a state where the first terminal is biased toward the first side by the elastic member, and is provided so as to be movable toward the second side by being pressed by the mating connector;
a second terminal that extends in the first direction and is positioned so as to be separated from the first terminal in a second direction that is perpendicular to the first direction; and
a flexible conductor that electrically connects the first terminal and the second terminal,
wherein the first terminal includes:
a first part that is provided on the first side of the elastic member and opposes the ceiling wall in the first direction and is capable of contacting the mating connector; and
a second part that extends toward the first side or the second side from an end portion on the second terminal side of the first part, and
the flexible conductor includes:
a first joint portion that is connected to the second part;
a second joint portion that is connected to the second terminal; and
an intermediate part that is positioned between the first joint portion and the second joint portion and protrudes toward the first side.

2. The terminal module according to claim 1,
wherein before mating, the intermediate part flexes so that one portion of the intermediate part is positioned closer to the second joint portion than an imaginary line that connects the first joint portion and a top portion on the first side of the intermediate part, and
during mating, the one portion extends so that the one portion moves from the second joint portion side of the imaginary line to a side opposite to the second joint portion.

3. The terminal module according to claim 1,
wherein the first joint portion is connected to a first surface on a second terminal side of the second part, and
the second joint portion is connected to a second surface on a second part side of the second terminal.

4. The terminal module according to claim 3,
wherein at least part of the first surface is at a position that overlaps the second surface in the first direction.

5. The terminal module according to claim 1,
wherein the pair of side walls include a guide surface that guides the first terminal, which is pressed by the mating connector and moves toward the second side, so as to move in a direction where the first terminal approaches the second terminal, and
an amount of movement of the first terminal toward the second side during mating is greater than an amount of movement in a direction approaching the second terminal.

6. A connector comprising:
the terminal module according to claim 1, and
a housing for housing the terminal module.

7. The connector according to claim 6,
wherein the housing includes an upper wall that is contacted by the ceiling wall and a rear wall that extends from a second terminal side end of the upper wall toward the first side,
before mating, a space surrounded by the upper wall, the rear wall, and the case is formed on the second side of the second part and the first joint portion, and
during mating, the second part and the first joint portion advance into the space.

8. The connector according to claim 6,
wherein the housing includes an inclined wall that acts as a partition between the mating connector and the flexible conductor during mating, and
the inclined wall includes an inclined surface that is positioned closer to the first joint portion than a top portion on the first side of the intermediate part and approaches the first joint portion from the first side toward the second side.

9. The connector according to claim 8,
wherein when the connector is removed from the mating connector, the inclined surface guides the intermediate part by contacting the intermediate part that moves toward the first side.

10. The connector according to claim 6,
further comprising a guide portion that is positioned in a space that is surrounded by the flexible conductor before the mating and is open to the second side,
wherein the guide portion contacts the intermediate part during the mating.
